(19) United States
(12) Patent Application Publication
(10) Pub. No.: US 2005/0268601 A1
(43) Pub. Date: Dec. 8, 2005

(54) Method for regenerating a particle filter

(76) Inventors: Andreas Pfaeffle, Wuestenrot (DE); Ralf Wirth, Leonberg (DE); Marcel Wuest, Korntal (DE); Dirk Samuelsen, Ludwigsburg (DE); Stefan Forthmann, Ludwigsburg (DE); Carsten Becker, Kernen (DE); Michael Kolitsch, Weissach (DE); Andreas Fritsch, Waiblingen (DE)

Correspondence Address: KENYON & KENYON, ONE BROADWAY, NEW YORK, NY, 10004, US

(21) Appl. No.: 11/101,064

(22) Filed: Apr. 7, 2005

(30) Foreign Application Priority Data
Jun. 4, 2004 (DE) 102004027509.2

(51) Int. Cl. B28B 3/00; F01N 3/00

(52) U.S. Cl. 60/295; 60/297

(57) ABSTRACT

A method for regenerating a particle filter of an internal combustion engine, of a diesel engine in particular, in which a characteristic quantity for the particle loading is determined to initiate regeneration. More accurate correlation of the particle mass is achieved in that a corrected loading characteristic quantity is formed from the loading characteristic quantity by modifying the loading characteristic quantity using a compression factor which takes into account different degrees of compression of the particles as a function of different operating states of the engine.

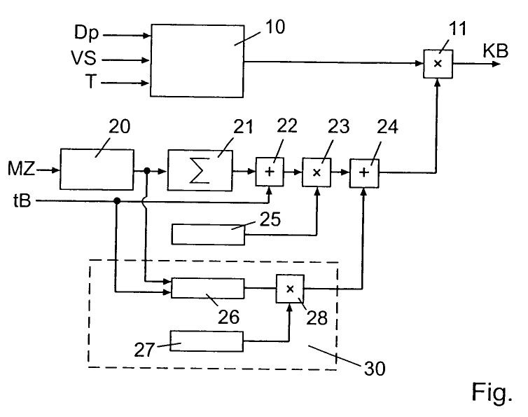

### FIELD OF THE INVENTION

The present invention relates to a method for regenerating a particle filter of an internal combustion engine, of a diesel engine in particular, in which a characteristic quantity for the particle loading is determined to initiate regeneration.

### BACKGROUND INFORMATION

In a method of this type which is assumed to be known (without printed documentation) to determine the loading state of a particle filter used for purifying the exhaust gas of an internal combustion engine, a diesel engine in particular, and to initiate regeneration if required, the pressure drop caused by the passage of the gas is measured, and the loading of the particle filter with particles (soot, ash) is correlated therefrom. It is assumed here that the same particle mass always produces the same pressure drop under the same flow conditions (volume flow, temperature).

An object of the present invention is to provide a more accurate correlation of the particle mass, the soot mass in particular, in the particle filter.

### SUMMARY OF THE INVENTION

This object is achieved according to the present invention. A corrected loading characteristic quantity is formed from the loading characteristic quantity by applying a compression factor to the loading characteristic quantity which takes into account different degrees of compression of the particles as a function of different operating states of the engine.

The measures according to the present invention assume that the particles deposited in the particle filter are compressed to different degrees at the time they are deposited as a function of the flow conditions (volume flow, temperature, pressure). These different degrees of compression result in different flow resistances of the particle layer. According to the present invention, those flow conditions are taken into account in the correlation of the particle mass from the measured differential pressure. Increased accuracy of the particle mass correlation is thus achieved, whereby a more cost-effective and fuel-saving operation of a particle filter system is made possible, while operational reliability is increased.

In an advantageous embodiment, the method calls for the compression factor to be averaged over the loading time, prior to being applied to the loading characteristic quantity.

Further advantageous embodiment variants call for the loading characteristic quantity to have applied to it the mean compression factor and/or the maximum value of the compression factor. By taking into account the maximum value, an additional safety factor, i.e., maximum system reliability, is ensured for protecting the particle filter, for example, against thermal destruction.

Different options for determining the particle mass correlation are available due to the fact that the mean compression factor and the maximum value of the compression factor have applied to them selectable weighting factors, whereby the influence of the mean compression factor and the maximum value may be easily predefined and accentuated in different manners.

### BRIEF DESCRIPTION OF THE DRAWING

The FIGURE illustrates the method according to the present invention.

### DETAILED DESCRIPTION

The FIGURE shows, in a block diagram, the procedure for forming a corrected loading characteristic quantity KB from a loading characteristic quantity determined in a step 10 by applying to the loading characteristic quantity using a compression factor which takes into account different degrees of compression of the particles as a function of different operating states of the engine.

The loading characteristic quantity is determined, by a method known per se, in step 10 from measured pressure differential Dp across the particle filter, exhaust gas volume flow VS and exhaust gas temperature T of the particle filter as a correlation of the particle mass in the particle filter. In addition, in a step 20, a compression factor associated with an instantaneous operating state MZ of the engine is determined. This compression factor is averaged in each case for a given loading time tB (time since the last regeneration) or a loading cycle of the particle filter in steps 21, 22. In addition, the maximum value of the compression factor since last regeneration tB is determined in a step 26. A weighted (in a step 23) sum of the mean value and of the weighted (in a step 28) maximum value is then calculated in a step 24 using predefinable weighting factors. For this purpose, in a step 25, a mean value factor is provided, which is multiplied by the mean compression factor for weighting the same in a step 23, and a maximum value factor is provided in a step 27, which is multiplied by the maximum compression factor for weighting the same in a step 28. The loading characteristic quantity determined in step 10 is multiplicatively corrected in a step 11 using the mean compression factor, the maximum compression factor, or the weighted compression factor formed from the weighting of the mean compression factor and the maximum compression factor to obtain corrected loading characteristic quantity KB.

Forming the maximum compression factor in step 26 and optionally carried out multiplying by maximum value factor 27 in step 28 result in a safety level 30, whereby additional protection of the particle filter against thermal destruction, i.e., increased system reliability, is achieved.

The above-described measures for forming and taking into account the compression factor are implementable in a device for regenerating a particle filter in a controller software, for example.

1. A method for regenerating a particle filter of an internal combustion engine, the method comprising:
determining a characteristic quantity for a particle loading to initiate regeneration; and
forming a corrected loading characteristic quantity from the loading characteristic quantity by applying a compression factor to the loading characteristic quantity which takes into account different degrees of compression of particles as a function of different operating states of the engine.

2. The method according to claim 1, wherein the engine is a diesel engine.

3. The method according to claim 1, further comprising averaging the compression factor over a loading time prior to being applied to the loading characteristic quantity.

4. The method according to claim 3, further comprising applying at least one of the average compression factor and a maximum value of the compression factor to the loading characteristic quantity.

5. The method according to claim 4, further comprising applying selectable weighting factors to the average compression factor and the maximum value of the compression factor.
